(19) United States
(12) Patent Application Publication
(10) Pub. No.: US 2022/0091452 A1
(43) Pub. Date: Mar. 24, 2022

(54) DRIVER ARRAY SUBSTRATE, DISPLAY PANEL AND DISPLAY DEVICE

(71) Applicant: HKC Corporation Limited, Shenzhen City (CN)

(72) Inventors: Wenqin ZHAO, Shenzhen (CN); Wei LI, Shenzhen city (CN)

(73) Assignee: HKC Corporation Limited, Shenzhen City (CN)

(21) Appl. No.: 17/339,541

(22) Filed: Jun. 4, 2021

(30) Foreign Application Priority Data
Sep. 23, 2020 (CN) 202011011643.8

(51) Int. Cl. G02F 1/1368; G02F 1/1362

(52) U.S. Cl. CPC G02F 1/1368; G02F 1/136213; G02F 1/136286

(57) ABSTRACT

Disclosed is a driver array substrate including a substrate, a plurality of first sub-pixels, a plurality of second sub-pixels, and a plurality of common electrodes; each first sub-pixel includes a first thin film transistor; each second sub-pixel includes a second thin film transistor; each first sub-pixel further includes a first storage capacitor, a first end of the first storage capacitor is connected to a drain of a corresponding first thin film transistor, and a second end thereof is connected to a first end of a corresponding common electrode; each second sub-pixel further includes a second storage capacitor, a capacitance value of the second storage capacitor is less than that of the first storage capacitor, a first end of the second storage capacitor is connected to a drain of a corresponding second thin film transistor, a second end thereof is connected to a first end of a corresponding common electrode.

### CROSS REFERENCE TO RELATED APPLICATION

The application claims priority to Chinese Patent Application No. 202011011643.8, filed on Sep. 23, 2020 and entitled “New Display Panel Architecture”, which is incorporated herein by reference in its entirety.

### TECHNICAL FIELD

The present disclosure relates to the field of display technology, and particularly to a driver array substrate, a display panel and a display device.

### BACKGROUND

With the development of the flat panel display technology, people have higher and higher requirements for image quality of display devices. A view angle is an important indicator to measure the image quality of the display devices. For liquid crystal display devices, colors displayed by most liquid crystal display devices change with the view angle. One reason is that, for the liquid crystal display panel, the deflection of the liquid crystal is controlled by applying a voltage to the liquid crystal, so as to implement the control of the backlight penetration. Due to the deflection of the liquid crystal, when the backlight passes through liquid crystal molecules, penetrations of light rays emitted by the backlight from different directions are different, that is, penetration rates varies with the angle, which causes different display brightness when viewed from different angles.

### SUMMARY

In view of this, as for the technical problem of different display brightness of the above-mentioned liquid crystal display device when viewed from different view angles, it is necessary to provide a driver array substrate, a display panel and a display device.

An embodiment of the present disclosure provides a driver array substrate, including a substrate, a plurality of first sub-pixels, a plurality of second sub-pixels, and a plurality of common electrodes provided on the substrate, each first sub-pixel includes a first thin film transistor, each second sub-pixel includes a second thin film transistor, the first sub-pixels and the second sub-pixels are arranged in both a first direction and a second direction of the substrate;

the first sub-pixels and the second sub-pixels are sequentially arranged alternately in the first direction, and the first sub-pixels and the second sub-pixels are sequentially alternately arranged in the second direction;

each first sub-pixel further includes a first storage capacitor, a first end of the first storage capacitor is connected to a drain of a corresponding first thin film transistor, and a second end of the first storage capacitor is connected to a first end of a corresponding common electrode;

each second sub-pixel further includes a second storage capacitor, a capacitance value of the second storage capacitor is less than that of the first storage capacitor, a first end of the second storage capacitor is connected to a drain of a corresponding second thin film transistor, a second end of the second storage capacitor is connected to a first end of a corresponding common electrode;

a second end of each common electrode is configured to be connected to a same potential.

In an embodiment, a ratio of the capacitance value of the first storage capacitor to that of the second storage capacitor equals to 3/2.

In an embodiment, a drain of each first thin film transistor and a common electrode are insulated from each other and overlap to form a first overlap region;

a drain of each second thin film transistor and a common electrode are insulated from each other and overlap to form a second overlap region;

an area of the first overlap region is greater than that of the second overlap region.

In an embodiment, an insulation layer is further provided on the substrate;

the common electrode covers a part of the substrate, and the insulation layer covers the common electrode and the substrate;

the drain of the first thin film transistor covers a part of the insulation layer and spatially overlaps the common electrode to form the first overlap region;

the drain of a second thin film transistor covers a part of the insulation layer and spatially overlaps the common electrode to form the second overlap region.

In an embodiment, a ratio of the area of the first overlap region to that of the second overlap region equals to 3/2.

A driver array substrate is provided, which includes a substrate, a plurality of first sub-pixels, a plurality of second sub-pixels, and a plurality of common electrodes provided on the substrate, each first sub-pixel includes a first thin film transistor, each second sub-pixel includes a second thin film transistor, the first sub-pixels and the second sub-pixels are arranged in both a first direction and a second direction of the substrate;

the first sub-pixels and the second sub-pixels are sequentially arranged alternately in the first direction, and the first sub-pixels and the second sub-pixels are sequentially arranged alternately in the second direction;

each first sub-pixel further includes a first storage capacitor, a first end of the first storage capacitor is connected to a drain of a corresponding first thin film transistor, and a second end of the first storage capacitor is connected to a gate of a thin film transistor of an adjacent sub-pixel;

each second sub-pixel further includes a second storage capacitor, a capacitance value of the second storage capacitor is less than that of the first storage capacitor, a first end of the second storage capacitor is connected to a drain of a corresponding second thin film transistor, and a second end of the second storage capacitor is connected to a gate of a thin film transistor of an adjacent sub-pixel.

In an embodiment, a ratio of the capacitance value of the first storage capacitor to that of the second storage capacitor equals to 3/2.

A display panel is provided, which includes the above-mentioned driver array substrate, a color film substrate matching the driver array substrate, and a liquid crystal layer provided between the driver array substrate and the color film substrate.

In an embodiment, the color film substrate includes a red color resist, a green color resist, and a blue color resist; color resists along the first direction are arranged in a loop according to an order indicated by the red color resist, the green color resist, and the blue color resist; color resists along the second direction are arranged in a loop according to an order indicated by the red color resist, the blue color resist, and the green color resist; and the first direction is perpendicular to the second direction.

An embodiment of the present disclosure further provides a display device, including the display panel provided the above embodiments.

On the above driver array substrate are provided the first storage capacitor and the second storage capacitor for maintaining the deflection voltage of the liquid crystal, the capacitance value of the first storage capacitor is greater than that of the second storage capacitor, such that a voltage applied on the liquid crystal corresponding to the first storage capacitor is greater than a voltage of the liquid crystal corresponding to the second storage capacitor, accordingly the deflection angle of the liquid crystal corresponding to the first storage capacitor is greater than the deflection angle of the liquid crystal corresponding to the second storage capacitor. When the backlight passes through the liquid crystals with different deflection angles, the backlight has different penetration rates corresponding to different view angles, that is, the backlight has the maximum penetration rate at the corresponding first view angle when passing through the first pixel liquid crystal, and the backlight has the maximum penetration rate at the corresponding second view angle when passing through the second pixel liquid crystal. In addition, the first sub-pixels and the second sub-pixels are arranged alternately along the first direction of the substrate, and the first sub-pixels and the second sub-pixels are also arranged alternately along the second direction of the substrate, thereby implementing an optimization of the wide view angle of the view angle of the liquid crystal display device in multiple directions.

### BRIEF DESCRIPTION OF THE DRAWINGS

FIG. 1 is a schematic diagram illustrating a driver array substrate according to an embodiment of the present disclosure.

FIG. 2 is a schematic diagram illustrating a driver array substrate according to another embodiment of the present disclosure.

FIG. 3 is a schematic structure diagram of a first sub-pixel according to an embodiment of the present disclosure.

### DETAILED DESCRIPTION

In order to better understand the purpose, technical solution and technical effects of the present disclosure, the present disclosure will be detailed below in conjunction with the accompanying drawings and embodiments. At the same time, it is stated that the embodiments described below are merely used for explaining the present disclosure, rather than limiting the present disclosure.

An embodiment of the present disclosure provides a driver array substrate, which includes a substrate 1, a plurality of sub-pixels, and a plurality of common electrodes 4. Each sub-pixel is arranged on the substrate; a sub-pixel includes a first sub-pixel 11 and a second sub-pixel 12; each first sub-pixel 11 includes a first thin film transistor 2; each second sub-pixel 12 includes a second thin film transistor. The first sub-pixel 11 and the second sub-pixel 12 are arranged in both a first direction and a second direction of the substrate 1; the first sub-pixel 11 and the second sub-pixel 12 are arranged alternately in the first direction, and the first sub-pixel 11 and the second sub-pixel 12 are arranged alternately in the second direction; each first sub-pixel 11 further includes a first storage capacitor 111; each second sub-pixel 12 further includes a second storage capacitor 121; a capacitance value of the second storage capacitor 121 is less than a capacitance value of the first storage capacitor 111.

A first end of the first storage capacitor 111 is connected to a drain 23 of the corresponding first thin film transistor 2, that is, the first end of the first storage capacitor 111 is connected to the drain 23 of the first thin film transistor 2 of the first sub-pixel 11 including the first stage capacitor 111. A second end of the first storage capacitor 111 is connected to a first end of a corresponding common electrode 4. Optionally, the first end of the first storage capacitor 111 can be directly connected to the drain 23 of the first thin film transistor 2 or indirectly connected to the drain 23 of the first thin film transistor 2 as long as the connection is an electric connection. Similarly, the second end of the first storage capacitor 111 can be directly connected to the first end of the corresponding common electrode 4 or indirectly connected to the first end of the common electrode 4, as long as the connection is the electric connection.

A first end of the second storage capacitor 121 is connected to a drain of a corresponding second thin film transistor, that is, the first end of the second storage capacitor is connected to the drain of the second thin film transistor of a second sub-pixel including the second storage capacitor 121. A second end of the second storage capacitor 121 is connected to a first end of a corresponding common electrode 4. Optionally, the first end of the second storage capacitor 121 can be directly connected to the drain of the second thin film transistor or indirectly connected to the drain of the second thin film transistor, as long as the connection is an electric connection Similarly, the second end of the second storage capacitor 121 can be directly connected to the first end of the common electrode 4 or indirectly connected to the first end of the common electrode 4, as long as the connection is an electric connection.

A second end of each common electrode is configured to be connected to a same electric potential.

Optionally, the driver array substrate further includes a number of scan lines 3 and a number of data lines 5. The data lines 5 and the scan lines 3 are conductive wires arranged on the substrate. The data lines 5 are arranged along the first direction of the substrate, and the scan lines 3 are arranged along the second direction of the substrate.

The first sub-pixels 11 are arranged on the substrate, a gate 21 of each first thin film transistor 2 is connected to a corresponding scan line 3, a source 22 is connected to a corresponding data line 5, and a drain 23 is connected to a first end of a corresponding first storage capacitor 111. After the first thin film transistor 2 receives a scan signal of the scan line 3, the source 22 and the drain 23 of the first thin film transistor 2 are turned on. At this time, the source 22 receives a display driving voltage from the data line 5 and outputs the display driving voltage to the drain 23, to match a common electrode of a color film substrate to form an electric field to drive the deflection of a liquid crystal in a corresponding region provided between the driver array substrate and the color film substrate. At the same time, the display driving voltage outputted by the drain 23 also charges the first storage capacitor 111. When the scan signal ends, the first thin film transistor 2 is turned off. During a period from turning off the first thin film transistor 2 to the next turning on, a liquid crystal in a region corresponding to the first sub-pixel 11 leaks electricity through the first thin film transistor 2, resulting in a voltage across the liquid crystal gradually decreases, and the deflection of the liquid crystal gradually reset. At this time, the first storage capacitor 111 is configured to provide a first holding voltage to the liquid crystal in the corresponding region to maintain the normal deflection of the liquid crystal.

Similarly, second sub-pixels 12 are arranged on the substrate 1, a gate of each second thin film transistor is connected to a corresponding scan line 3, a source is connected to a corresponding data line 5, a drain is connected to a first end of a corresponding second storage capacitor; a second end of each second storage capacitor 121 is connected to a first end of a corresponding common electrode 4. A second end of each common electrode 4 is configured to be connected to a same electric potential. After the gate of the second thin film transistor receives a scan signal of the scan line 3, the source and drain are turned on, the corresponding data line 5 outputs a driving voltage to the drain through the source, and the drain matches the common electrode 4 on the color film substrate to form an electric field, to drive a deflection of a liquid crystal in a corresponding region provided between the driver array substrate and the color film substrate. At the same time, the drain outputs the display driving voltage to the second storage capacitor 121 to charge the second storage capacitor 121. The second storage capacitor 121 is configured to provide a second holding voltage to a liquid crystal in a corresponding region during a period from the second thin film transistor is turned off to the next turning on, to maintain the normal deflection of the liquid crystal. Of course, in order to form an electric field to drive the deflection of the liquid crystal, in some types of liquid crystal panels, the common electrode of the color film substrate can also be provided on the driver array substrate, such as a liquid crystal display panel using the In-Plane Switching (IPS) technology, which is understood and can be implemented by those skilled in the art, and will not be repeated here.

Since the capacitance value of the second storage capacitor 121 is less than the capacitance value of the first storage capacitor 111, the second holding voltage is less than the first holding voltage, and a deflection angle of a second pixel liquid crystal is less than a deflection angle of a first pixel liquid crystal, which causes the penetration rate of the backlight at a corresponding first view angle when passing through the first pixel liquid crystal is maximum, and the penetration rate of the backlight at a corresponding second view angle when passing through the second pixel liquid crystal is maximum, so that better brightness of the display frame can be obtained when viewed from multiple angles, accordingly a range of view angles is extended.

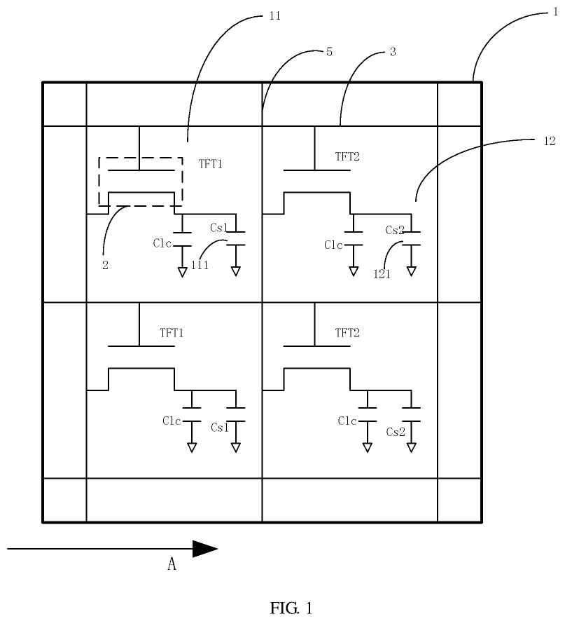

Referring to FIG. 1, the first sub-pixels 11 and the second sub-pixels 12 are arranged in both the first direction and the second direction of the substrate. The first sub-pixels 11 and the second sub-pixels 12 are sequentially arranged alternately in the first direction. For example, in FIG. 1, which takes a direction A as the first direction of the substrate, any two adjacent sub-pixels along the direction A include a first sub-pixel 11 and a second sub-pixel 12. In such a way, liquid crystals in regions corresponding to any two adjacent sub-pixels in the direction A can be deflected at different angles, thereby implementing a wide view angle.

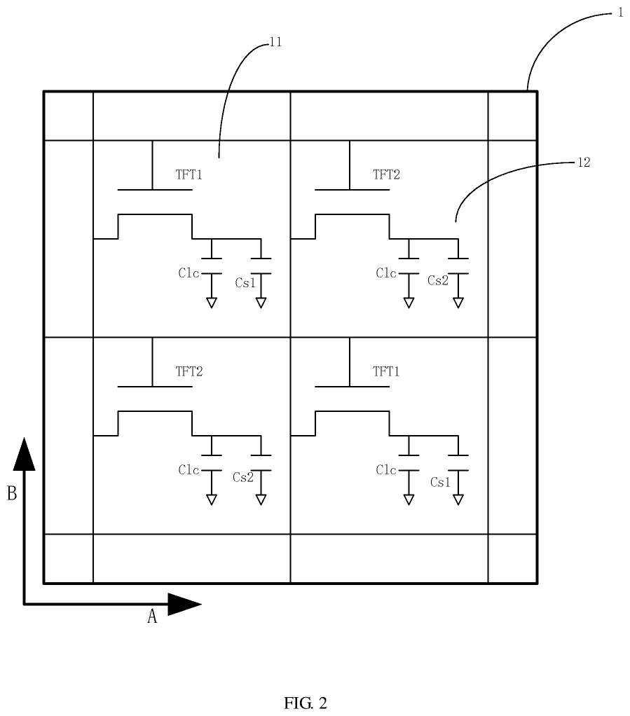

Referring to FIG. 2, in an embodiment, the first sub-pixels 11 and the second sub-pixels 12 are sequentially arranged alternately in both the first direction and the second direction, such that liquid crystals in regions corresponding to any two adjacent sub-pixels in the first direction can be reflected at different angles; at the same time, the liquid crystals in regions corresponding to any two adjacent sub-pixels in the second direction are also deflected at different angles, thereby achieving the wide view angle in the two directions and ensuring the display quality at various view angles.

Optionally, according to a capacitance determinant C=εS/4πkd, where ε is a dielectric constant, π is a ratio of a circumference of a circle to a diameter thereof, k is an electrostatic force constant, S is a frontal projected area of two poles of a capacitor, and d is a distance between the two poles of the capacitor. The capacitance values of the first storage capacitor and the second storage capacitor can be set respectively by setting the frontal projected area of the two poles of the storage capacitor, or by setting the distance between the two poles of the storage capacitor, or by setting the dielectric material between the two poles of the storage capacitor, to obtain different dielectric constants, so as to respectively set the magnitudes of capacitances of the first storage capacitor and the second storage capacitor.

In the conventional driver array substrate, a storage capacitor of each sub-pixel is configured as a capacitor with a same capacitance value, thus a display device with a substrate using the conventional drive principle has a single view angle during the display. In the driver array substrate provided by the embodiments of the present disclosure, the capacitance value of the first storage capacitor is greater than that of the second storage capacitor. Such arrangement can make the first pixel liquid crystal and the second pixel liquid crystal deflect to different angles, and accordingly a wide view angle is achieved.

In an embodiment, a ratio of the capacitance value of the first storage capacitor to the capacitance value of the second storage capacitor is equal to 3/2.

In an embodiment, the drain 23 of each first thin film transistor 2 is insulated from the common electrode 4, and the drain 23 of the first thin film transistor 2 overlaps the common electrode 4 to form a first overlap region. The drain of each second thin film transistor is insulated from the common electrode 4, and the drain 23 of the first thin film transistor 2 overlaps the common electrode 4 to form a second overlap region. An area of the first overlap region is greater than that of the second overlap region. The first overlap region between the drain 23 of the first thin film transistor 2 and the common electrode 4 forms a first storage capacitor, and the second overlap region between the drain 23 of the second thin film transistor and the common electrode 4 forms a second storage capacitor. That the drain 23 of the first thin film transistor 2 is insulated from the common electrode 4 refers to that there is no electrical conduction between the drain 23 of the first thin film transistor and the common electrode 4, for example, the drain 23 of the first thin film transistor 2 has no contact with the common electrode 4, which can implement the insulation therebetween; in another example, a medium is provided between the drain 23 of the first thin film transistor 2 and the common electrode 4, accordingly the insulation therebetween can also be implemented. Similarly, the drain of the second thin film transistor is insulated from the common electrode 4, which can also be set by referring to the insulation operation between the drain 23 of the first thin film transistor and the common electrode 4. The first overlap region refers to a spatial overlap, which can be an overlap region formed by the drain 23 of the first thin film transistor and the common electrode 4 in a direction parallel to the substrate 1, or can be an overlap region formed by the drain 23 of the first thin film transistor and the common electrode 4 in a direction perpendicular to the substrate 1, as long as there is an overlap portion between the first thin film transistor and the common electrode 4 Similarly, the second overlap region has a similar arrangement to the first overlap region, that is, an overlap region which is formed by the drain of the second thin film transistor and the common electrode 4 in a direction parallel to the substrate 1, or an overlap region which is formed by the drain of the second thin film transistor and the common electrode 4 in a direction perpendicular to the substrate 1, as long as there is an overlap portion between the drain of the second thin film transistor and the common electrode 4.

Optionally, during a manufacturing process, the drain 23 of the first thin film transistor 2 and the drain of the second thin film transistor can be manufactured simultaneously, and the common electrode 4 corresponding to the drain 23 of the first thin film transistor and the common electrode 4 corresponding to the drain of the second thin film transistor are electrodes with a same property. Therefore, the first overlap region and the second overlap region only differ in area, the area of the first overlap region is greater than that of the second overlap region, that is, the capacitance value of the first storage capacitor is greater than that of the second storage capacitor.

In the embodiment, the first overlap region is formed between the first thin film transistor and the common electrode 4, the second overlap region is formed between the second thin film transistor and the common electrode 4, the first storage capacitor and the second storage capacitor are formed through such arrangement, and the area of the first overlap region is made greater than that of the second overlap region, so that the capacitance value of the first storage capacitor is greater than that of the second storage capacitor, and accordingly the effect of different deflection angles of the liquid crystals is achieved.

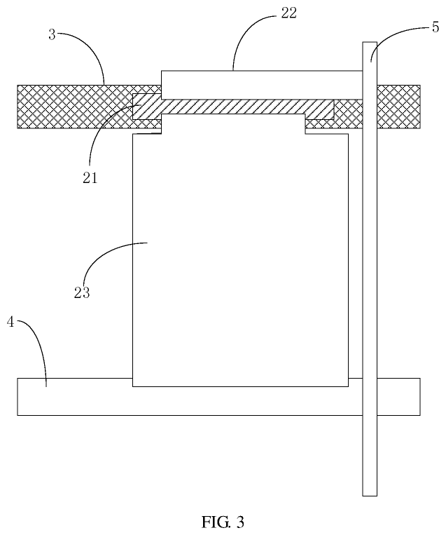

In an embodiment, referring to FIG. 3, an insulation layer is further provided on the substrate 1. The common electrode 4 covers a part of the substrate 1, and the insulation layer covers the common electrode 4 and the substrate 1. The drain 23 of the first thin film transistor 2 is provided on the insulation layer and partially covers the insulation layer. At the same time, the drain 23 of the first thin film transistor 2 spatially overlaps the common electrode 4 to form the first overlap region Similarly, the drain of the second thin film transistor is provided on the insulation layer and partially covers the insulation layer. At the same time, the drain of the second thin film transistor spatially overlaps the common electrode 4 to form the second overlap region. The first overlap region forms the first storage capacitor, and the second overlap region forms the second storage capacitor. Optionally, in the manufacturing process of the substrate, the drain 23 of the first thin film transistor 2 and the drain of the second thin film transistor 2 are manufactured simultaneously, that is, the materials of these two are the same. The common electrode 4 corresponding to the drain of the first thin film transistor 23 and the common electrode 4 corresponding to the drain of the second thin film transistor are electrodes with a same property, and optionally, both of which are made of the same material. An insulation layer covers the common electrode 4 and the substrate 1, that is, an insulation layer is provided between the drain 23 of the first thin film transistor and the common electrode 4, and the insulation layer serves as a medium between the drain 23 of the first thin film transistor and the common electrode 4. Similarly, an insulation layer is also provided between the drain of the second thin film transistor and the common electrode 4, that is, a dielectric material is the same as that between the first thin film transistor and the common electrode 4, and a dielectric constant is the same. Accordingly, the first overlap region and the second overlap region only differ in area. When the drain 23 of the first thin film transistor and the drain of the second thin film transistor are manufactured by exposure, developing, and deposition, overlap regions with different areas can be formed only when the exposure patterns of the two drains are set to be different, so that the capacitance value of the first storage capacitor can be configured to be greater than the capacitance value of the second storage capacitor.

Optionally, a ratio of the area of the first overlap region to the area of the second overlap region equals to 3/2. Since the first overlap region and the second overlap region only differ in area, an ratio between areas is a ratio between corresponding capacitances, i.e., the ratio of the capacitance value of the first storage capacitor to the capacitance value of the second storage capacitor is set to 3/2 by setting the ratio between areas of the overlap regions.

Optionally, the driver array substrate can further be provided with a number of third sub-pixels, and a third sub-pixel includes a third thin film transistor and a third storage capacitor. A gate of each third sub-pixel is connected to a corresponding scan line 3, a source thereof is connected to a corresponding data line 5, a drain thereof is connected to a first end of a corresponding third storage capacitor, and a second end of the third storage capacitor is connected to a corresponding common electrode 4. A capacitance value of the third storage capacitor is different from the capacitance value of the first storage capacitor and the capacitance value of the second storage capacitor. Through such arrangement, the display panel corresponding to the driver array substrate can have a larger view angle.

An embodiment of the present disclosure further provides a driver array substrate, which includes a substrate and a plurality of sub-pixels provided on the substrate.

Each sub-pixel is arranged on the substrate, and each sub-pixel includes a first sub-pixel and a second sub-pixel. Each first sub-pixel includes a first thin film transistor, and each second sub-pixel includes a second thin film transistor. Each first sub-pixel further includes a first storage capacitor, and each second sub-pixel further includes a second storage capacitor, and a capacitance value of the second storage capacitor is less than a capacitance value of the first storage capacitor.

A first end of the first storage capacitor is connected to a drain of a corresponding first thin film transistor, i.e., the first end of the first storage capacitor is connected to the drain of the first thin film transistor of the first sub-pixel including the first storage capacitor. A second end of the first storage capacitor is connected to a gate of a thin film transistor of an adjacent sub-pixel. Optionally, the first end of the first storage capacitor can be directly connected to the drain of the first thin film transistor, or can be indirectly connected to the drain of the first thin film transistor, as long as the connection is an electric connection. Similarly, the second end of the first storage capacitor can be directly connected to a gate of a thin film transistor of an adjacent sub-pixel, or indirectly connected to the gate of the thin film transistor of the adjacent sub-pixel, as long as the connection is an electric connection. The adjacent sub-pixel referred to here can be an adjacent first sub-pixel or an adjacent second sub-pixel, as long as it is a sub-pixel adjacent to the first storage capacitor.

A first end of the second storage capacitor is connected to a drain of a corresponding second thin film transistor, i.e., the first end of the second storage capacitor is connected to the drain of the second thin film transistor of the second sub-pixel including the second storage capacitor. A second end of the second storage capacitor is connected to a gate of a thin film transistor of an adjacent sub-pixel. Optionally, the first end of the second storage capacitor can be directly connected to the drain of the second thin film transistor, or indirectly connected to the drain of the second thin film transistor, as long as the connection is an electric connection. Similarly, a second end of the second storage capacitor can be directly connected to a gate of a thin film transistor of an adjacent sub-pixel, or indirectly connected to the gate of the thin film transistor of the adjacent sub-pixel, as long as the connection is the electric connection. The adjacent sub-pixel referred to here refers to a sub-pixel adjacent to the second storage capacitor.

Since the capacitance value of the second storage capacitor is less than that of the first storage capacitor, the second holding voltage is less than the first holding voltage, and the deflection angle of the second pixel liquid crystal is less than that of the first pixel liquid crystal, resulting in that the penetration rate of the backlight at a corresponding first view angle when passing through the first pixel liquid crystal is maximum, and the penetration rate of the backlight at a corresponding second view angle when passing through the second pixel liquid crystal is maximum, thereby expanding the range of the view angle.

Optionally, according to a capacitance determinant C=εS/4πkd, where ε is a dielectric constant, π is a ratio of a circumference of a circle to a diameter thereof, k is an electrostatic force constant, S is a frontal projected area of two poles of the capacitor, and d is a distance between the two poles of the capacitor, the capacitance values of the first storage capacitor and the second storage capacitor can be set respectively by setting the frontal projected area of the two poles of the storage capacitor, or by setting the distance between the two poles of the storage capacitor, or by setting the dielectric material between the two poles of the storage capacitor, to obtain different dielectric constants, so as to set the magnitudes of capacitances of the first storage capacitor and the second storage capacitor respectively.

In the driver array substrate provided in the embodiment, the capacitance value of the first storage capacitor is greater than that of the second storage capacitor, such that the deflection angle of the first pixel liquid crystal is different from that of the second pixel liquid crystal, thereby implementing a wide view angle. At the same time, since the first storage capacitor and the second storage capacitor are both connected to the scan line 3, there is no need to provide a common electrode 4 on the hardware, which can improve an aperture ratio.

In an embodiment, a ratio of the capacitance value of the first storage capacitor to that of the second storage capacitor equals to 3/2.

An embodiment of the present disclosure further provides a display panel, which includes the driver array substrate provided by any of the above embodiments, a color film substrate matching the driver array substrate, and a liquid crystal layer provided between the driver array substrate and the color film substrate. In the display panel provided by the embodiment of the present disclosure, the deflection voltage of the first pixel liquid crystal is different from that of the second pixel liquid crystal, accordingly the deflection angle is different, so that a wide view angle can be implemented. The color film substrate can be a plate consisting of one or more colors of optical filters. Each optical filter can precisely select a small range of light waves to pass through, and reflect other light waves with undesired wavebands to enable the human eyes to receive saturated light of a certain color. For example, red, green, and blue filters can be arranged sequentially at intervals.

In an embodiment, the color film substrate includes a red color resist, a green color resist, and a blue color resist; and the color resists along the first direction are arranged in a loop according to an order indicated by the red color resist, the green color resist, and the blue color resist. The color resists in the two directions are arranged in a loop according to an order indicated by the red color resist, the blue color resist and the green color resist; and the first direction is perpendicular to the second direction. By adopting such arrangement of color resists matching the setting of the magnitude relationship between the capacitances of the first storage capacitor and the second storage capacitor in the driver array substrate, not only the wide-angle display can be implemented, but also the color shift under a large view angle can be reduced, accordingly the quality of pixel display can be improved. The interpretation of the first direction and the second direction is the same as that in the above-mentioned embodiments, and is not repeated here. In a manner known to those skilled in the art, the color resists are arranged in a one-to-one correspondence with the aforementioned sub-pixels.

An embodiment of the present disclosure further provides a display device, which includes the display panel provided in the aforementioned embodiments. The display device in the embodiment can be a mobile phone, a computer, a television, and other devices.

The technical features of the above-mentioned embodiments can be combined arbitrarily. In order to make the description concise, all possible combinations of the various technical features in the above-mentioned embodiments are not described. However, as long as there is no contradiction in the combination of these technical features, all should be considered as the scope of the present disclosure.

The above-mentioned embodiments are merely several exemplary embodiments of the present disclosure, and the description is more specific and detailed, but should not be understood as limiting the scope of the present disclosure. It should be noted that those of ordinary skill in the art can make several variations and improvements without departing from the concept of the present disclosure, and these all fall within the protection scope of the present disclosure. Therefore, the protection scope of the present disclosure should be subject to the appended claims.

What is claimed is:

1. A driver array substrate, comprising a substrate, a plurality of first sub-pixels, a plurality of second sub-pixels, and a plurality of common electrodes provided on the substrate, each first sub-pixel comprising a first thin film transistor, each second sub-pixel comprising a second thin film transistor, wherein the first sub-pixels and the second sub-pixels are arranged in both a first direction and a second direction of the substrate;
the first sub-pixels and the second sub-pixels are sequentially arranged alternately in the first direction, and the first sub-pixels and the second sub-pixels are sequentially alternately arranged in the second direction;
each first sub-pixel further comprises a first storage capacitor, a first end of the first storage capacitor is connected to a drain of a corresponding first thin film transistor, and a second end of the first storage capacitor is connected to a first end of a corresponding common electrode;
each second sub-pixel further comprises a second storage capacitor, a capacitance value of the second storage capacitor is less than that of the first storage capacitor, a first end of the second storage capacitor is connected to a drain of a corresponding second thin film transistor, a second end of the second storage capacitor is connected to a first end of a corresponding common electrode;
a second end of each common electrode is configured to be connected to a same potential.

2. The driver array substrate according to claim 1, wherein a ratio of the capacitance value of the first storage capacitor to that of the second storage capacitor equals to 3/2.

3. The driver array substrate according to claim 1, wherein a drain of each first thin film transistor and a common electrode are insulated from each other and overlap to form a first overlap region;
a drain of each second thin film transistor and a common electrode are insulated from each other and overlap to form a second overlap region;
an area of the first overlap region is greater than that of the second overlap region.

4. The driver array substrate according to claim 3, wherein an insulation layer is further provided on the substrate;
the common electrode covers a part of the substrate, and the insulation layer covers the common electrode and the substrate;
the drain of the first thin film transistor covers a part of the insulation layer and spatially overlaps the common electrode to form the first overlap region;
the drain of the second thin film transistor covers a part of the insulation layer and spatially overlaps the common electrode to form the second overlap region.

5. The driver array substrate according to claim 4, wherein a ratio of the area of the first overlap region to that of the second overlap region equals to 3/2.

6. The driver array substrate according to claim 2, wherein a drain of each first thin film transistor and a common electrode are insulated from each other and overlap to form a first overlap region;
a drain of each second thin film transistor and a common electrode are insulated from each other and overlap to form a second overlap region;
an area of the first overlap region is greater than that of the second overlap region.

7. The driver array substrate according to claim 1, further comprising a number of scan lines and a number of data lines, wherein the data lines and the scan lines are conductive wires arranged on the substrate, the data lines are arranged along the first direction of the substrate, and the scan lines are arranged along the second direction of the substrate.

8. The driver array substrate according to claim 7, wherein the first sub-pixels are arranged on the substrate, a gate of each first thin film transistor is connected to a corresponding scan line, a source is connected to a corresponding data line, and a drain is connected to a first end of a corresponding first storage capacitor.

9. The driver array substrate according to claim 7, wherein the second sub-pixels are arranged on the substrate, a gate of each second thin film transistor is connected to a corresponding scan line, a source is connected to a corresponding data line, a drain is connected to a first end of a corresponding second storage capacitor, a second end of each second storage capacitor is connected to a first end of a corresponding common electrode.

10. The driver array substrate according to claim 1, wherein a drain of a first thin film transistor and a drain of a second thin film transistor are manufactured simultaneously, and a common electrode corresponding to the drain of the first thin film transistor and a common electrode corresponding to the drain of the second thin film transistor are electrodes with a same property.

11. The driver array substrate according to claim 4, wherein the drain of the first thin film transistor and the drain of the second thin film transistor are manufactured simultaneously.

12. The driver array substrate according to claim 4, wherein the common electrode corresponding to the drain of the first thin film transistor and the common electrode corresponding to the drain of the second thin film transistor are electrodes with a same property.

13. The driver array substrate according to claim 1, further comprising a number of third sub-pixels, wherein each third sub-pixel comprises a third thin film transistor and a third storage capacitor, a gate of each third sub-pixel is connected to a corresponding scan line, a source of each third sub-pixel is connected to a corresponding data line, a drain of each third sub-pixel is connected to a first end of a corresponding third storage capacitor, and a second end of the third storage capacitor is connected to a corresponding common electrode, a capacitance value of the third storage capacitor is different from the capacitance value of the first storage capacitor and the capacitance value of the second storage capacitor.

14. The driver array substrate according to claim 1, wherein the capacitance values of the first storage capacitor and the second storage capacitor are set respectively according to a capacitance determinant C=εS/4πkd, wherein ε is a dielectric constant, π is a ratio of a circumference of a circle to a diameter thereof, k is an electrostatic force constant, S is a frontal projected area of two poles of a capacitor, and d is a distance between the two poles of the capacitor.

15. A driver array substrate, comprising a substrate, a plurality of first sub-pixels, a plurality of second sub-pixels, and a plurality of common electrodes provided on the substrate, each first sub-pixel comprising a first thin film transistor, each second sub-pixel comprising a second thin film transistor, wherein the first sub-pixels and the second sub-pixels are arranged in both a first direction and a second direction of the substrate;
the first sub-pixels and the second sub-pixels are sequentially arranged alternately in the first direction, and the first sub-pixels and the second sub-pixels are sequentially arranged alternately in the second direction;
each first sub-pixel further comprises a first storage capacitor, a first end of the first storage capacitor is connected to a drain of a corresponding first thin film transistor, and a second end of the first storage capacitor is connected to a gate of a thin film transistor of an adjacent sub-pixel;
each second sub-pixel further comprises a second storage capacitor, a capacitance value of the second storage capacitor is less than that of the first storage capacitor, a first end of the second storage capacitor is connected to a drain of a corresponding second thin film transistor, and a second end of the second storage capacitor is connected to a gate of a thin film transistor of an adjacent sub-pixel.

16. The driver array substrate according to claim 15, wherein a ratio of the capacitance value of the first storage capacitor to that of the second storage capacitor equals to 3/2.

17. The driver array substrate according to claim 15, wherein the capacitance values of the first storage capacitor and the second storage capacitor are set respectively according to a capacitance determinant C=εS/4πkd, wherein ε is a dielectric constant, π is a ratio of a circumference of a circle to a diameter thereof, k is an electrostatic force constant, S is a frontal projected area of two poles of the capacitor, and d is a distance between the two poles of the capacitor.

18. A display panel, comprising the driver array substrate according to claim 1, a color film substrate matching the driver array substrate, and a liquid crystal layer provided between the driver array substrate and the color film substrate.

19. The display panel according to claim 18, wherein the color film substrate comprises a red color resist, a green color resist, and a blue color resist; color resists along the first direction are arranged in a loop according to an order indicated by the red color resist, the green color resist, and the blue color resist; color resists along the second direction are arranged in a loop according to an order indicated by the red color resist, the blue color resist, and the green color resist; and the first direction is perpendicular to the second direction.

20. A display device, comprising the display panel of claim 18.
